(19) United States
(12) Patent Application Publication
(10) Pub. No.: US 2018/0351946 A1
(43) Pub. Date: Dec. 6, 2018

(54) PRIVACY-ENHANCED BIOMETRIC AUTHENTICATED ACCESS REQUEST

(71) Applicant: GM Global Technology Operations LLC, Detroit, MI (US)

(72) Inventors: Thomas M. Forest, Macomb, MI (US); Mohamed A. Layouni, Warren, MI (US); Evripidis Paraskevas, Royal Oak, MI (US)

(21) Appl. No.: 15/608,166

(22) Filed: May 30, 2017

(51) Int. Cl. H04L 29/06; H04L 9/32

(52) U.S. Cl. CPC H04L 63/0861; H04L 9/3247; H04L 63/0435; H04L 9/3242; H04L 63/0807

(57) ABSTRACT

Embodiments include methods, systems and computer readable storage medium for privacy-enhanced biometric access enrollment. The method includes receiving, by a processor, a biometric signing request (BSR) associated with a request for access rights from a user, wherein the BSR comprises hashed biometric data. The method further includes generating, by the processor, a first biometric signature using at least a portion of the BSR. The method further includes generating, by the processor, a second biometric signature based on at least a portion of the BSR. The method further includes generating, by the processor, an authorization token based on at least the first biometric signature and the second biometric signature. The method further includes sending, by the processor, the authorization token to one or more access control entities or a user computing device for conveyance to the one or more access control entities for authentication.

The subject disclosure relates to biometric authentication, and more specifically to providing access rights using privacy-enhanced biometric authentication.

Biometric information is metric related data based on human characteristics, for example, fingerprints, voice recognition, iris or retinal scan information, or the like. Such biometric information can be used to authenticate the identity of an individual. The authentication can be used for a variety of reasons, for example, granting access to a door, a computer, a bank account or the like. Biometric information is personal information which an individual may not desire others to obtain for many reasons, for example, privacy concerns.

Accordingly, it is desirable to provide a system that uses biometric authentication to allow access, for example, vehicle access to a user, but also addresses privacy concerns by validating the user's biometric information without storing the user's biometric information on a backend system.

### SUMMARY

In one exemplary embodiment, a method for privacy-enhanced biometric access enrollment is disclosed. The method includes receiving, by a processor, a biometric signing request (BSR) associated with a request for access rights from a user, wherein the BSR comprises hashed biometric data. The method further includes generating, by the processor, a first biometric signature using at least a portion of the BSR. The method further includes generating, by the processor, a second biometric signature based on at least a portion of the BSR. The method further includes generating, by the processor, an authorization token based on at least the first biometric signature and the second biometric signature. The method further includes sending, by the processor, the authorization token to one or more access control entities or a user computing device for conveyance to the one or more access control entities for authentication.

In addition to one or more of the features described herein, the BSR can additionally include a cryptographic nonce that can be used to prevent an inference that the biometric data associated with the user has previously been used for enrollment. The BSR can also include a first context string that is publicly known and defined by an authentication protocol. The first biometric signature can be further based on a private key and a second context string. The second biometric signature can be further based on a private key and reservation details. The access control entity can be a vehicle.

In another exemplary embodiment, a system for privacy-enhanced biometric access enrollment is disclosed herein. The system includes a memory and processor in which the processor receives a biometric signing request (BSR) associated with a request for access rights from a user, wherein the BSR comprises hashed biometric data. The processor further generates a first biometric signature using at least a portion of the BSR. The processor further generates a second biometric signature based on at least a portion of the BSR. The processor further generates an authorization token based on at least the first biometric signature and the second biometric signature. The processor further sends the authorization token to one or more access control entities or a user computing device for conveyance to the one or more access control entities for authentication.

In yet another exemplary embodiment a computer readable storage medium for privacy-enhanced biometric access enrollment is disclosed herein. The computer readable storage medium includes receiving a biometric signing request (BSR) associated with a request for access rights from a user, wherein the BSR comprises hashed biometric data. The computer readable storage medium further includes generating a first biometric signature using at least a portion of the BSR. The computer readable storage medium further includes generating a second biometric signature based on at least a portion of the BSR. The computer readable storage medium further includes generating an authorization token based on at least the first biometric signature and the second biometric signature. The computer readable storage medium further includes sending the authorization token to one or more access control entities or a user computing device for conveyance to the one or more access control entities for authentication.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment according to one or more embodiments;

FIG. 2 is a block diagram illustrating one example of a processing system for practice of the teachings herein;

FIG. 3 is a flow diagram of a method for biometric access enrollment according to one or more embodiments; and

FIG. 4 is a flow diagram of a method for biometric access validation according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

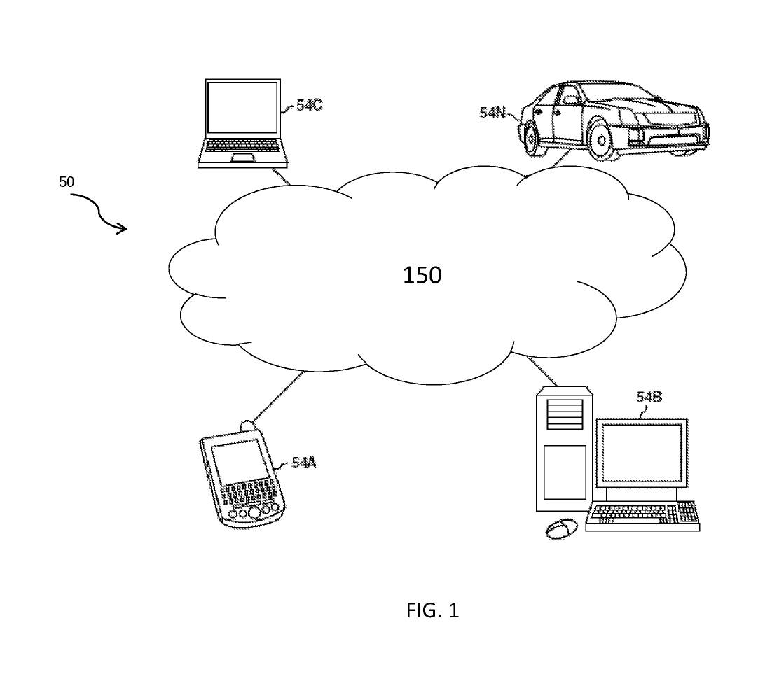

In accordance with an exemplary embodiment, FIG. 1 illustrates a computing environment 50. As shown, computing environment 50 comprises one or more computing devices, for example, personal digital assistant (PDA) or cellular telephone (mobile device) 54A, server 54B, computer 54C, and/or automobile onboard computer system 54N, which are connected via network 150. The one or more computing devices may communicate with one another using network 150.

Network 150 can be, for example, a local area network (LAN), a wide area network (WAN), such as the Internet, a dedicated short range communications network, or any combination thereof, and may include wired, wireless, fiber optic, or any other connection. Network 150 can be any combination of connections and protocols that will support communication between mobile device 54A, server 54B, computer 54C, and/or automobile onboard computer system 54N, respectively.

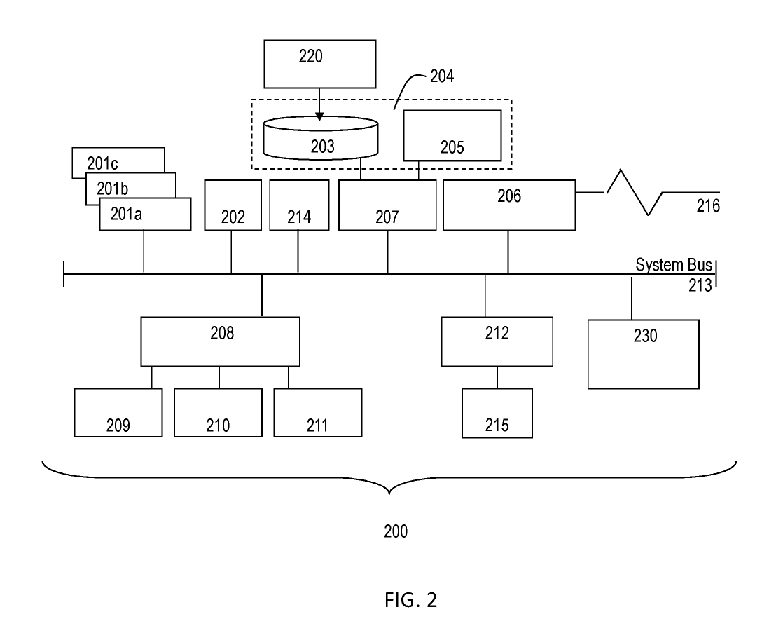

In accordance with an exemplary embodiment, FIG. 2 illustrates a processing system 200 for implementing the teachings herein. The processing system 200 can form at least a portion of the one or more computing devices, such as mobile device 54A, server 54B, computer 54C, and/or automobile onboard computer system 54N. The processing system 200 may include one or more central processing units (processors) 201a, 201b, 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage device 205 are collectively referred to herein as mass storage 204. Operating system 220 for execution on the processing system 200 may be stored in mass storage 204. A network adapter 206 interconnects bus 213 with an outside network 216 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

The one or more computing devices may further include a transmitter and receiver (not shown), to transmit and receive information. The signals sent and received may include data, communication, and/or other propagated signals. Further, it should be noted that the functions of transmitter and receiver could be combined into a signal transceiver.

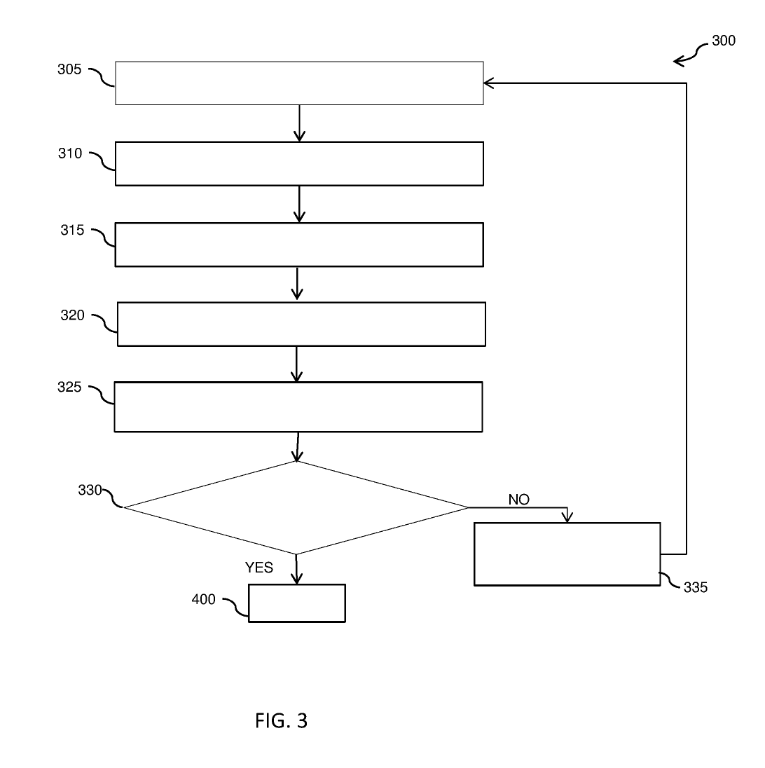

In accordance with an exemplary embodiment, FIG. 3 depicts a flow diagram of a method for biometric access enrollment. At block 305, a user initiates communication with a business entity or group to obtain access rights from one or more access control entities, for example, access rights to use one or more vehicles (ride/vehicle sharing), a building, a computer or the like. The user may initiate the communication on a user computing device (mobile device 54A and/or computer 54C) using a mobile application, a desktop application, or the like. The communication can generate a biometric signing request (BSR) based on biometric data for the user stored on the user computing device, using, for example, a trusted platform module. At block 310, as part of generating the BSR, the user computing device can generate a cryptographic hash of the user's biometric data (Biomₑₙᵣₒₗₗ) using, for example, a cryptographic nonce (Nonce_{BSR}, an arbitrary number used only once in a cryptographic communication) as part of an authentication protocol. In addition, as part of generating the BSR, the user computing device can generate a customization string (CString1, context string), which is publicly known and defined by the authentication protocol that uniquely identifies an enrollment request portion of the authentication protocol. At block 315, the user computing device can send the generated BSR, which is a hash of the cryptographic nonce, the user's biometric data, and the customization string, along with the cryptographic hash itself to a server, for example, server 54B for processing. The BSR sent to the server 54B can resemble the following: BSR={H(Nonce_{BSR}∥CString1∥Biomₑₙᵣₒₗₗ), Nonce_{BSR}}.

At block 320, the server 54B can generate a first biometric signature of desired content (B) using a server based private key. The first biometric signature can be constructed in a usual manner, for example, signing a cryptographic hash of B and then returning both B and the signature on B. The hash of B can be constructed as follows: (B={H (CString2∥BSR[0]), BSR[1]}), where (CString2) is a new context/customization string, BSR[0] is H(NonceBSR∥Cstring1∥Biomₑₙᵣₒₗₗ), and BSR[1] is NonceBSR. The new customization string (context string) can be different from the customization string generated by the user computing device and is publicly known and defined by the authentication protocol that uniquely identifies an enrollment signing portion of the authentication protocol.

The server 54B can sign a hash digest to verify an authenticity of the hash digest. The first biometric signature can be verified by another party using the server's 54B public key, which is known in advance. By verifying the first biometric signature a party (such as the vehicle) can determine that the server 54B approves of the content desired to be signed, “B”.

The first biometric hash generated by the server 54B, on hash digest B is {B, Sig_{ServerPrivKey}(B)}). The server 54B can generate {B, Sig_{ServerPrivKey}(B)}, the first biometric signature, without storing the user's actual biometric data and the cryptographic nonce prevents the server 54B from inferring whether the same biometric data has been used before. For example, if a user attempts to enroll the same biometric data more than once, the biometric data will have the same hash. As a result, even though the server 54B does not contain the actual biometric data, the server 54B can prevent enrollment more than once because the hash is the same. Accordingly, by using a different cryptographic nonce for each enrollment even if the underlying biometric data is the same the server 54B will receive a different hash.

At block 325, the method for biometric access enrollment further includes sending the first biometric signature to an enrollment entity, for example, a vehicle containing automobile onboard computer system 54N, for authentication. The server 54B can send the first biometric signature to the vehicle by generating an authorization token (C), which includes a second biometric signature (Sig_{ServerPrivKey}(C)) generated by the server 54B based on the first biometric signature (Sig_{ServerPrivKey}(B)) along with other details relevant to the user's requested access, for example, reservation details (Reserv.details). The private keys used to generate the first biometric signature and the second biometric signature can be the same or different private keys. The reservation details may include information associated with a vehicle type, reservation time, use duration, authorization token expiration time/duration, etc. The authorization token format can be the following: {C=[Reserv.details, B, Sig_{ServerPrivKey}(B)], SigServerPrivKey(C)}.

The server 54B can also send the first biometric signature and authorization token to the user computing device instead of the vehicle. Returning the first biometric signature and authorization token to the user computing device allows the vehicle to remain offline. Accordingly, communication with the vehicle may not be needed during biometric access.

Accordingly, the authorization token allows a business entity or group to control user/customer access rights to one or more access control entities. The business entity or group can use the authorization token to manage and provide shared services, for example, a car sharing service, to one or more users.

At block 330, the vehicle uses a public key sent by the server 54B to verify the first biometric signature, and the authorization token (second signature). If either the first biometric signature or second biometric signature cannot be verified, at block 335, authentication fails and the method returns to block 305. If both the first biometric signature and second biometric signature can be verified, the method proceeds to block 400 for validation.

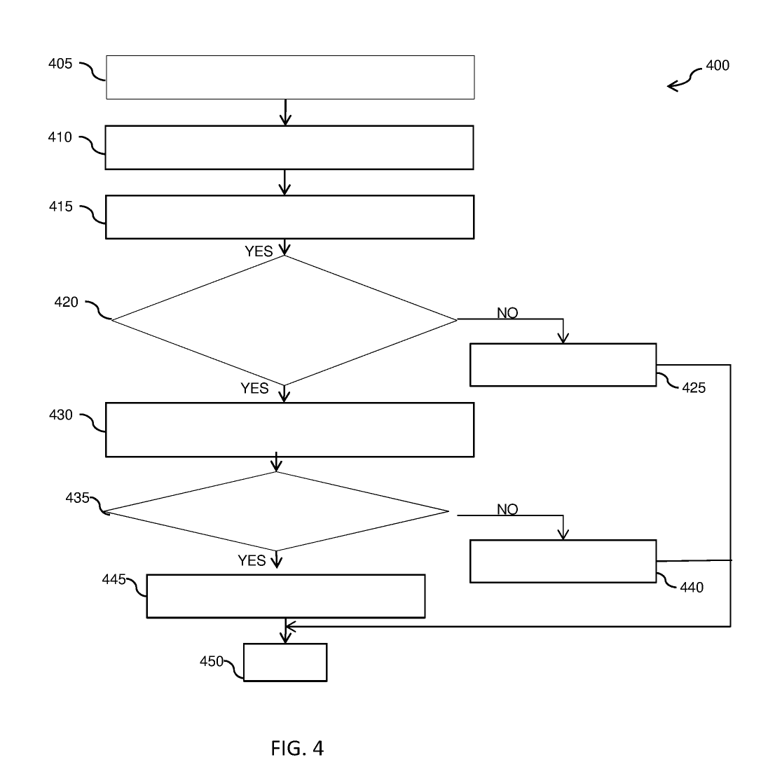

In accordance with an exemplary embodiment, FIG. 4 depicts a flow diagram of a method for biometric access validation. During validation 400, at block 405, the user can provide new biometric data to the vehicle using a user computing device, a storage device, a bar code, or any other manner to transfer the biometric data. For example, the user can provide a fingerprint to a vehicle fingerprint sensor. The biometric data transferred from the user to the vehicle can be transferred using a variety of cryptographic methods in order to prevent an unauthorized capture of the biometric data by a third party. The biometric data transfer can entail, for example, using an encrypted and authenticated channel to transfer the biometric data (such as secured Bluetooth, secured WiFi, or TLS over some layer), requiring the user to encrypt the biometric data prior to the transmission to the vehicle using either symmetric or asymmetric cryptography, or possibly using keying material provided by the server 54B.

At block 410, the user can also provide the biometric data (Biomₑₙᵣₒₗₗ) stored on the user computing device and nonce information (Nonce_{BSR}) associated with the stored biometric data (blocks 305 and 310) to the vehicle. At block 415, the vehicle can generate a hash of the user's biometric data and the associated nonce information to generate a hash digest. At block 420, the vehicle determines if the hash digest generated by the vehicle equals a non-expired authorization token sent by the server 54B to the vehicle. If the hash digest does not equate to a non-expired authorization token sent to the vehicle by the server 54B, the method proceeds to block 425 where the vehicle denies access to the vehicle and the method ends at block 450. If the hash digest does equate to a non-expired token sent to the vehicle by the server 54B, the method proceeds to block 430.

At block 430, the vehicle conducts a similarity analysis between the new biometric data and the stored biometric data. The similarity analysis determines whether the new biometric data and the stored biometric data are similar enough to represent the same user. For example, the similarity analysis can be done using a Hamming distance, which counts a number of bits that differ between the new biometric data and the stored biometric data.

At block 435, the vehicle determines whether the result of the similarity analysis is below a predetermined threshold. If the result of the similarity analysis is above the predetermined threshold, the method proceeds to block 440 where the vehicle denies access to the vehicle and the method ends at block 450. If the result of the similarity analysis is below the predetermined threshold, the method proceeds to block 445 where the vehicle allows the user to access the vehicle. At block 450, the method ends.

Accordingly, the embodiments disclosed herein allow a user to send a cryptographic hash of the user's biometric data to a server instead of sending actual biometric data to obtain access rights to an enrollment entity. The hash is signed by the server, and then provided to a target access control entity/vehicle. The user then provides the original biometric data directly to the target vehicle, which can be validated by checking the server provided signature of the hash. As a consequence, the server does not directly interact with the user's actual biometric data and cannot infer the actual biometric data from the hashed biometric data. Accordingly, a user's privacy is enhanced when interacting with the disclosed embodiments because the disclosed embodiments protect against the unnecessary disclosure and storage of the user's actual biometric data private information.

Technical effects and benefits of the disclosed embodiments include, but are not limited to the following: the disclosed system relieves the server from the burden of having to manage and secure a biometrics database; the system can accommodate a car-sharing system capable of allowing a customer to use different vehicles; the disclosed system does not require sensitive biometric information to be sent to the server; and the disclosed system can operate using a variety of biometric information, for example, iris codes, fingerprints, facial scans, hand geometry, vein patterns, voice prints, etc.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for privacy-enhanced biometric access enrollment, the method comprising:
receiving, by a processor, a biometric signing request (BSR) associated with a request for access rights from a user, wherein the BSR comprises hashed biometric data;
generating, by the processor, a first biometric signature using at least a portion of the BSR;
generating, by the processor, a second biometric signature based on at least a portion of the BSR;
generating, by the processor, an authorization token based on at least the first biometric signature and the second biometric signature; and
sending, by the processor, the authorization token to one or more access control entities or a user computing device for conveyance to the one or more access control entities for authentication.

2. The method of claim 1, wherein the BSR further comprises a cryptographic nonce.

3. The method of claim 2, wherein the cryptographic nonce is used to prevent an inference that the biometric data associated with the user has previously been used for enrollment.

4. The method of claim 1, wherein the BSR further comprises a first context string, wherein the customization string is publicly known and defined by an authentication protocol.

5. The method of claim 1, wherein the first biometric signature is further based on a private key and a second context string.

6. The method of claim 1, wherein the second biometric signature is further based on a private key and reservation details.

7. The method of claim 1, wherein the access control entity is a vehicle.

8. A system for privacy-enhanced biometric access enrollment, the system comprising:
a memory; and
a processor coupled to the memory, wherein the processor:
receives a biometric signing request (BSR) associated with a request for access rights from a user, wherein the BSR comprises hashed biometric data;
generates a first biometric signature using at least a portion of the BSR;
generates a second biometric signature based on at least a portion of the BSR;
generates an authorization token based on at least the first biometric signature and the second biometric signature; and
sends the authorization token to one or more access control entities or a user computing device for conveyance to the one or more access control entities for authentication.

9. The system of claim 8, wherein the BSR further comprises a cryptographic nonce.

10. The system of claim 9, wherein the cryptographic nonce is used to prevent an inference that the biometric data associated with the user has previously been used for enrollment.

11. The system of claim 8, wherein the BSR further comprises a first context string, wherein the customization string is publicly known and defined by an authentication protocol.

12. The system of claim 8, wherein the first biometric signature is further based on a private key and a second context string.

13. The system of claim 8, wherein the second biometric signature is further based on a private key and reservation details.

14. The system of claim 8, wherein the access control entity is a vehicle.

15. A non-transitory computer readable storage medium having program instructions embodied therewith, the program instructions readable by a processor to cause the processor to perform a method for privacy-enhanced biometric access enrollment comprising:
receiving a biometric signing request (BSR) associated with a request for access rights from a user, wherein the BSR comprises hashed biometric data;
generating a first biometric signature using at least a portion of the BSR;
generating a second biometric signature based on at least a portion of the BSR;
generating an authorization token based on at least the first biometric signature and the second biometric signature; and
sending the authorization token to one or more access control entities or a user computing device for conveyance to the one or more access control entities for authentication.

16. The computer readable storage medium of claim 15, wherein the BSR further comprises a cryptographic nonce.

17. The computer readable storage medium of claim 16, wherein the cryptographic nonce is used to prevent an inference that the biometric data associated with the user has previously been used for enrollment.

18. The computer readable storage medium of claim 15, wherein the BSR further comprises a first context string, wherein the customization string is publicly known and defined by an authentication protocol.

19. The computer readable storage medium of claim 15, wherein the first biometric signature is further based on a private key and a second context string.

20. The computer readable storage medium of claim 15, wherein the second biometric signature is further based on a private key and reservation details.

21. A method for privacy-enhanced biometric access validation, the method comprising:
receiving, by a processor, first biometric data from a user;
receiving, by the processor, hashed biometric data, wherein the hashed biometric data is created from second biometric data from the user;
determining, by the processor, whether a hash digest associated with the hashed biometric data is equivalent to at least one non-expired authorization token;
performing, by the processor, a similarity analysis on the first biometric data and the second biometric data upon a determination that the hash digest is equivalent to at least one non-expired authorization token; and
allowing, by the processor, access to an access control entity to the user when a result of the similarity access is above a predetermined threshold.

22. The method of claim 21, wherein the authorization token is received from a server, a storage device, a bar code or a user computing device.

23. The method of claim 21, wherein the hashed biometric data is based on a cryptographic nonce.

24. The method of claim 21, wherein the access control entity is a vehicle.

25. The method of claim 24, wherein the vehicle is associated with a ride sharing service.
